(19) United States
(12) Patent Application Publication
(10) Pub. No.: US 2026/0328003 A1
(43) Pub. Date: Oct. 22, 2026

(54) SCALABLE ADDITIVE MANUFACTURING CEMENT PRINTER

(71) Applicant: Worcester Polytechnic Institute, Worcester, MA (US)

(72) Inventors: Mohammad Mahdi Agheli Hajiabadi, Worcester, MA (US); Warwick Barker, Worcester, MA (US); Colin McGinty, Worcester, MA (US); Natanel Pinkhasov, Worcester, MA (US); Luke Sanneman, Worcester, MA (US); Marc Wehbe, Worcester, MA (US)

(21) Appl. No.: 19/655,017

(22) Filed: Apr. 22, 2026

Related U.S. Application Data
(60) Provisional application No. 63/792,657, filed on Apr. 22, 2025.

(51) Int. Cl. E04G 21/04; B33Y 10/00; B33Y 30/00; B33Y 40/00

(52) U.S. Cl. CPC E04G 21/0436; B33Y 10/00; B33Y 30/00; B33Y 40/00

(57) ABSTRACT

A compact, autonomous mobile robot is capable of continuously 3D-printing cement while traversing and building atop previously printed layers. The system integrates a screw-based positive displacement pump, a modular multi-nozzle distribution mechanism, and a LiDAR-driven perception stack for real-time edge detection and navigation. A turret-mounted extruder enables bi-directional wall printing without chassis rotation, improving efficiency in constrained spaces. Experimental validation with a full-scale prototype demonstrates successful deposition of consecutive cement layers, confirming the feasibility of scalable, height-agnostic construction from a mobile platform. These results establish a foundation for future autonomous, multi-robot swarms aimed at rapid, decentralized construction in remote, off-grid, or extraterrestrial environments, offering a lightweight alternative to traditional gantry and robotic arm systems.

### RELATED APPLICATIONS

This patent application claims the benefit under 35 U.S.C. § 119(e) of U.S. Provisional Patent App. No. 63/792,657, filed Apr. 22, 2025, entitled “SCALABLE ADDITIVE MANUFACTURING CEMENT PRINTER,” incorporated herein by reference in entirety.

### BACKGROUND

Construction materials such as concrete are typically poured or spread in a viscous fluid form into a mold for curing into a solid, load bearing mass with substantial compression force tolerance. Concrete itself is a mixture of Portland cement, sand and aggregate that reacts with water to a brief (about 90 minute) viscous or pourable phase, and cures in a 28 day cycle, although substantial strength is attained in a rather short time. Mixed (wet) concrete typically has about a 90 minute “shelf life” by which it should be poured and/or formed into an expected shape to remain undisturbed until solidified. Mixing, transporting, and forming the concrete in an appropriate time interval is a labor intensive task requiring multiple workers and machines in a unified and timely manner.

### SUMMARY

A compact, autonomous mobile robot is capable of continuously 3D-printing cement or concrete while traversing and building atop previously printed layers. The system integrates a screw-based positive displacement pump, a modular multi-nozzle distribution mechanism, and a LiDAR-driven perception stack for real-time edge detection and navigation. A turret-mounted extruder enables bi-directional wall printing without chassis rotation, improving efficiency in constrained spaces. Experimental validation with a full-scale prototype demonstrates successful deposition of consecutive cement layers, confirming the feasibility of scalable, height-agnostic construction from a mobile platform. These results establish a foundation for future autonomous, multi-robot swarms aimed at rapid, decentralized construction in remote, off-grid, or extraterrestrial environments, offering a lightweight alternative to traditional gantry and robotic arm systems.

Extrusion and deposition approaches common to ink deposition printing and injection molding have been attempted on a larger scale with denser, more structurally sound materials. Configurations herein are based, in part, on the observation that automation and robotic technology have been attempted with building and construction approaches such as wall formation and foundation laying. Conventional approaches have been attempted to include multiple nozzle/gantry systems or adapting nozzle size, shape, and orientation such as extended pumping arms passing over a deposition form.

Unfortunately, conventional approaches suffer from the shortcoming that they generally require a footprint larger than the article to be constructed or formed. Gantry approaches require an overhead, longitudinal member extending and supported beyond the perimeter of the construction form. Extended nozzle and pumping approaches require a distal pump and reservoir of material outside the perimeter of the constructed article.

Configurations herein substantially overcome the shortcomings of conventional gantry and larger-than-site automated approaches by providing an autonomous deposition robot for layered deposition onto an iteratively traversable form capable of multiple passes in a form factor smaller than the deposition path. Wheeled robots having a deposition nozzle wider than the path they traverse provides a series of layers that can be traversed by the robot itself for successive layer generation. By extending the deposition beyond the wheel width, and ensuing a supportive, non-deforming level surface, the robot lies within the footprint of the formed article for successive buildup of iterative layers for defining a constructed article. Conventional approaches fail to combine high-viscosity cement extrusion, edge tracking via onboard LiDAR, and autonomous mobility to print while traversing previously deposited structures. The disclosed approach introduces and validates such an integration, demonstrating a proof-of-concept for height-independent mobile 3D concrete printing (3DCP).

In further detail, the disclosed approach provides an autonomous extrusion unit device for layered deposition of a construction material, including a hopper for aggregating the construction material, and an extruder for advancing the construction material from the hopper. A wheeled or tracked transport drive is configured to provide mobility of the unit, and a nozzle coupled to the extruder deposits the construction material such as concrete in a traversable layer, where the traversable layer is configured for a subsequent pass by the transport drive. Each of the units establishes or receives a fluidic aggregation of a construction material, and deposits the construction material onto a construction substrate. The unit spreads and smooths the construction material into a traversable layer, directs transport drive over the traversable layer and deposits a subsequent traversable layer on top of the traversable layer, such that each traversable layer is configured for a subsequent pass by the transport drive based on a width of the traversable layer being greater than a width of the transport drive, thereby providing an accumulation of layers. A fleet or swarm of units may deploy on a construction site for forming a structure of integrated, aggregations of layers each forming a wall or structural member of a structure.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of a construction environment suitable for use with configurations herein;

FIG. 2 is a perspective view of an extrusion robot in the environment of FIG. 1;

FIG. 3 shows a plurality of “swarm” robots collaboratively forming a construction article in the environment of FIG. 1;

FIG. 4 shows an extrusion nozzle for metered deposition of a predetermined width and thickness of a construction material;

FIGS. 5A-5C show path scanning of a deposition path formed by the configurations of FIGS. 1-4;

FIG. 6 shows a side cutaway view of an extruder coupled to the extrusion nozzle of FIG. 4 in the robot of FIG. 2; and

FIG. 7 shows an example of a processor control circuit for operation and guidance of the extrusion robot of FIG. 2.

### DETAILED DESCRIPTION

The global construction industry is increasingly challenged by rising material waste, labor shortages, and environmental impacts. Among the most resource-intensive processes is the use of concrete, where formwork and manual labor significantly drive up both cost and carbon footprint. Conventional concrete pouring methods require temporary formwork that is often non-reusable, contributing to waste and inefficiency. In parallel, extended project timelines caused by labor delays or sequential curing processes further reduce profitability and scalability in construction. Large-scale construction challenges become even more critical in challenging or remote environments. This stems from the mere reliance of current technology on human labor and the use of slow, large-sized, and heavy machinery, demanding substantial site preparation and on-site machinery installations and posing a critical bottleneck in various construction scenarios

Configurations herein address these challenges, offering a small mobile 3D-printing robot that eliminates the need for human labor or heavy machinery. An autonomous, mobile construction robot is capable of depositing construction materials while traversing and printing atop previously printed layers. By combining a compact mobile base, a turret-mounted extrusion system, and real-time LiDAR perception, this autonomous robotic unit enables height-agnostic, continuous 3D printing.

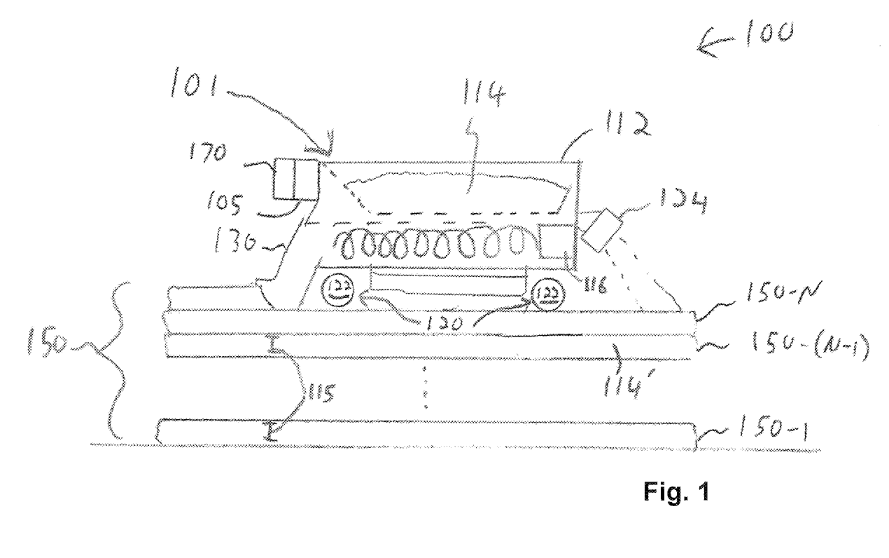

FIG. 1 is a diagram of a construction environment 100 suitable for use with configurations herein. Referring to FIG. 1, an autonomous extrusion unit 101 is defined by a device for layered deposition of a construction material, including a hopper 112 for aggregating the construction material 114, and an extruder 116 for advancing the construction material from the hopper 112. A transport drive 120 defined by a plurality of wheels 122 is configured to provide mobility of the unit 101, and a nozzle 130 is coupled to the extruder 116 for depositing the construction material in traversable layers 150, such that each traversable layer 150-1..150-N is configured for a subsequent pass by the transport drive 120.

The autonomous unit 101 provides effective, mobile 3D concrete printing for structures significantly larger than the robot’s footprint. The system extrudes cement sufficiently fluid enough to flow through the pump and nozzle network but viscous enough to maintain shape during layer curing. Its compact chassis allows it to traverse atop partially cured layers, enabling continuous vertical construction. Multiple independent pumps can print sub-sections of a wall simultaneously, allowing gaps or internal cavities for later insulation or reinforcement. The predetermined thickness defines a thickness 115 of the construction material 114 in deposited layers 150, such that the thickness is based on a non-deforming bearing capacity of a weight of the unit 101 during the subsequent pass. In other words, the deposited, curing construction material 114’ has a sufficient firmness to resist deformation as the transport drive 120 passes over it on a successive pass. This may be achieved by a combination of a viscosity of the deposited material 114, curing of the material 114’ and a weight of the unit 101 bearing on the aggregated layers 150.

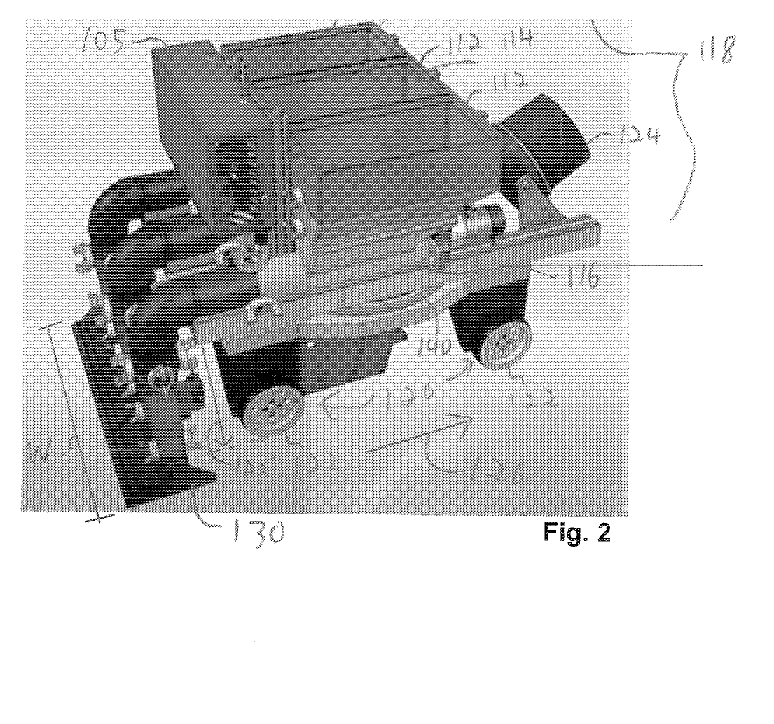

FIG. 2 is a perspective view of an extrusion robot in the environment of FIG. 1. Referring to FIGS. 1 and 2, the nozzle 130 has a shape for forming the traversable layer 150 in a predetermined width W and thickness 115, such that the nozzle 130 extends the width W beyond a width 122’ of the transport drive 120, whereby the width W of the layer accommodates the successive pass of the transport drive 101 by maintaining shape and resisting buckling or deforming on successive passes.

From a system perspective, the system is intended to deposit the construction material 114 behind the forward direction of the robot to prevent contact between the chassis and freshly printed layers 150, ensure that deposited layers cure without interference or malformation while enabling subsequent autonomous traversal of the robot. Longevity is preserved by utilizing materials and coatings for all cement-contacting components that resist chemical degradation and withstand the pressures imposed by the pumping system, provided by the extruder 116 including an auger and motor, and the nozzle 130.

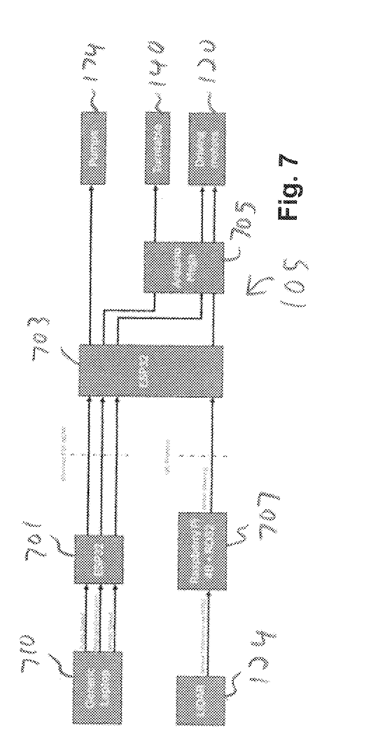

Directional alternation is provided by a rotational linkage 140 between the transport drive 120 and an upper chassis including the nozzle 130, hopper 112 and extruder, such that the rotational linkage 140 is configured to rotate the nozzle to an opposed side of the unit 101, where the opposed side corresponds to deposition in an opposed direction from a travel direction for depositing the most recent traversable layer 150. In other words, the rotational linkage 140, such as a turntable, allows the upper chassis 118 to rotate 180^{o} to begin depositing a successive layer 150 or course in an opposite direction. A scanning medium (scanner) 124 such as a Lidar transducer or array scans a forward direction 126 of travel while the nozzle 130 deposits rearward of the direction of travel. A control unit 105, discussed further below in FIG. 7, provides electronic switching, power and logic from a processor based device.

The hopper 114 may further include a replenishment inlet in fluidic communication with the hopper for receiving additional granular supply. A sufficient supply of the construction material 114, typically a granular or powder medium mixed with water or another activation fluid, is maintained on board the unit 101. Alternatively, the replenishment inlet may be coupled to at least one of a tubular vessel, an aerial drone and an external bulk carrier for keeping the hopper 114 supplied. For example, a suspended tube from a material repository may extend to a plurality of units around a construction site 100. A drone may deposit repeated loads of the construction material, or an adjacent or co-located supply vehicle may maintain adequate supply for periodic refilling of the hopper 112 and any needed activation fluid.

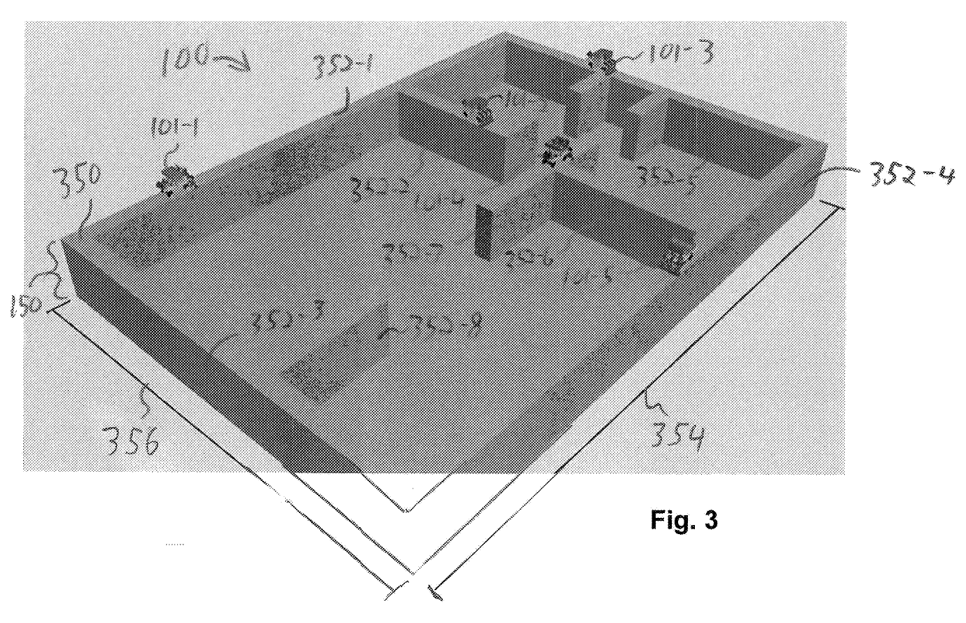

FIG. 3 shows a plurality of “swarm” robots collaboratively forming a construction article in the environment of FIG. 1. Referring to FIGS. 1-3, the disclosed approach is operable for autonomous, multi-robot swarms aimed at rapid, decentralized construction in remote, off-grid, or extraterrestrial environments, offering a lightweight alternative to traditional gantry and robotic arm systems. In FIG. 3, a plurality of robot units 101-1..101-5 form a construction article 350 from multiple layer 150 iterations forming interconnecting walls 352-1..352-8. Note that each individual unit 101 is considerably smaller than the length 354 and width 356 of the article 350, and therefore adapted for tight clearance areas and locations where construction frames and equipment extending beyond the dimensions of the article would not be accommodated.

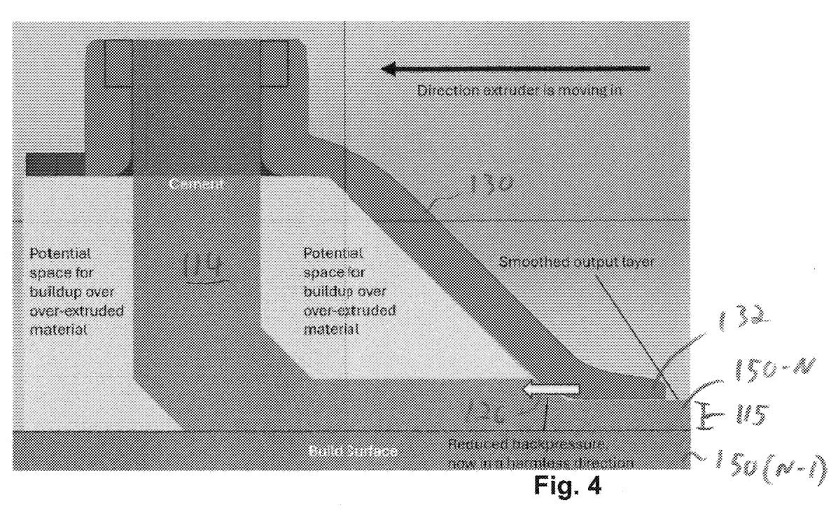

FIG. 4 shows an extrusion nozzle for metered deposition of a predetermined width and thickness of a construction material 114 as it passes through the nozzle 130 under pressure from the extruder 116. Referring to FIGS. 1-4, the nozzle 130 includes a spreader 132 extending rearward from a transit direction 126 of the unit 101 for fluidic communication with the construction material. The spreader 132 may be a continuously molded shape of the nozzle 130 or may be a separate, flat, straight member attached to the nozzle 130 at the point of deposition. The spreader 132 defines the height 115 of the traversable layer 150-N above an accumulation of the traversable layers 150-N-1, hence defining the thickness of each respective layer 150. A typical prototype forms layers between 2 and 4 inches thick, however any suitable thickness may be defined based on the elevation of the spreader 132 above the surface traversed by the transport drive 120.

Collectively, the assembly of the nozzle 130 and the spreader 132 achieve smoothing of the material into wide, thin, and flat layers that enable rapid drying and support subsequent traversal, as well as the need to merge the outputs of multiple nozzle outlets into a continuous layer. The spreader 130 effectively decouples smoothing from distribution, allowing cement from each of multiple extruder 116 outlets to contact the build surface undisturbed before being merged and shaped horizontally into a continuous, level layer downstream of deposition, utilizing the force of the chassis driving forward for smoothing, which eliminated nozzle clogging caused by backpressure. In the case of concrete, for example, greater pumping power and the use of viscosity-modifying accelerants as additives to the material 114—both employed in industry— would serve to improve material deposition and shaping. Any suitable viscosity modifier to the extruded material may facilitate the formation of flat, smooth layers 150 suitable for successive passes by the transport drive 120. Larger or a greater number of wheels 122, and/or a track system, may server to distribute the unit 101 weight over a greater area for avoiding deformation of the previous layers 150-(N-1).

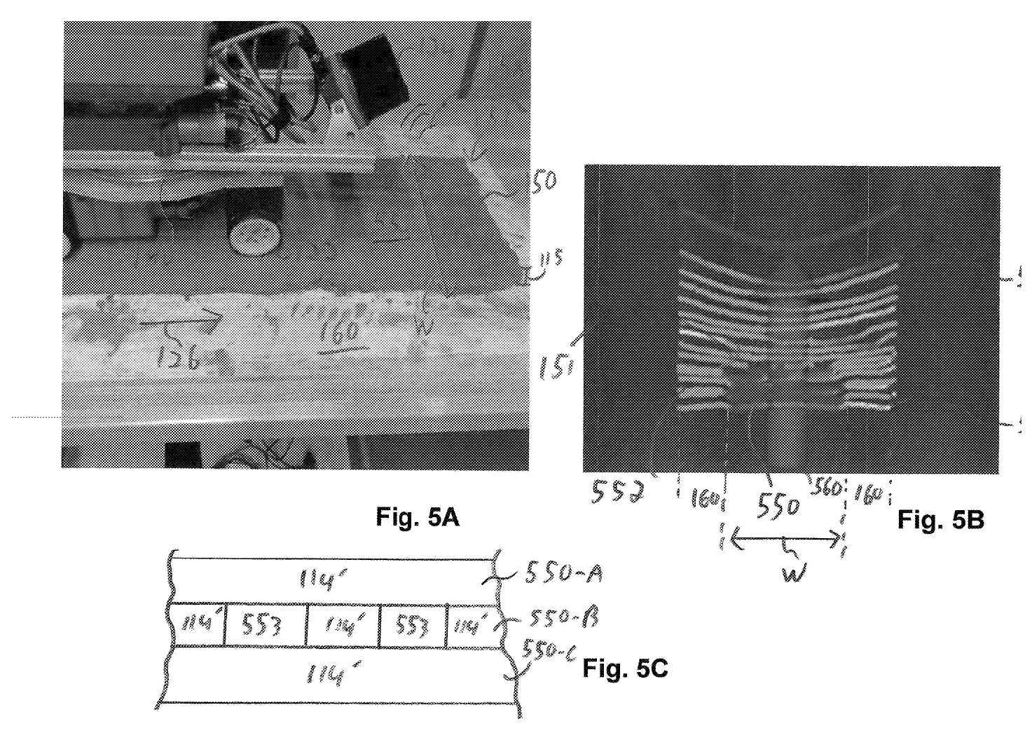

FIGS. 5A-5C show path scanning of a deposition path 550 formed by the configurations of FIGS. 1-4. Referring to FIGS. 1-5C, the surface scanner 124 is disposed on a forward transit side 126’ of the unit 101 and coupled to the drive 120 for returning signals indicative of a deposited region 550 a line of travel 560 within the width W and a termination 151 of the traversable layer 150 in the transit direction 126. The returned signals 158 include scan passes 554-1..554-N of scan lines 552 indicating a bounds of the traversable layer 150 including the width W and the termination 151 for aligning a current layer 150-N with the previous layer 150-(N-1). Outlying region 160, denoted by a different color or shade on the scan lines 552, provide steering guidance to the wheels 122 for maintaining the drive 120 aligned on the line of travel 560.

As the nozzle 130 resides at the unit 101 rear of the transit direction 126, the rotational linkage 140, typically a turntable or turret, rotates to accommodate the length of the unit 101 in tight clearance environments so that a final segment of the layer 150-N aligning with the termination 151 of the previous layer 150-(N-1) forms a uniform thickness 115 of each layer 150 up to the termination 151.

Alternatively or in addition, the deposited layer 150 may include linear segments 550-A..550-C corresponding to the nozzle 130 and/or hopper 112 and extruder 116 configurations. Each linear segment 550A..550C may also include periodic alternations, such as gaps 553 in the middle segment 550-B to allow for utility chases, insulation or simply to minimize material while not compromising strength of the deposited construction material 114’.

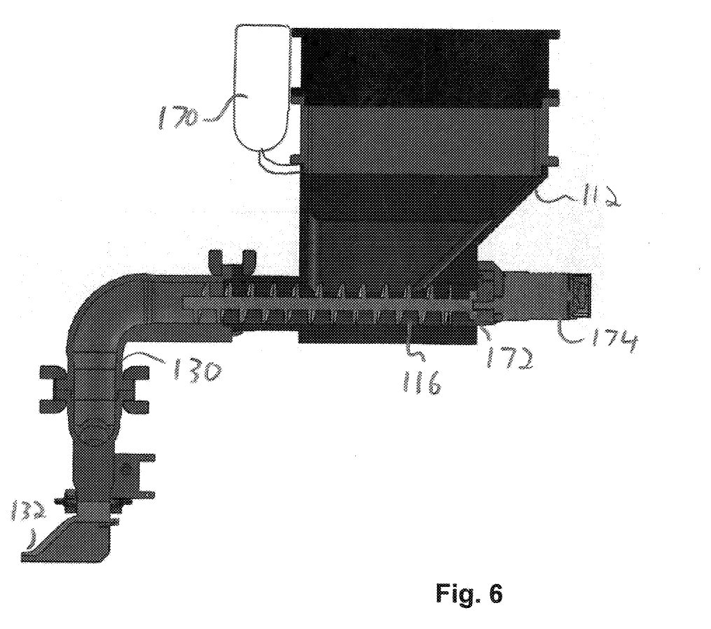

FIG. 6 shows a side cutaway view of an extruder 116 coupled to the extrusion nozzle 130 of FIG. 4 in the robot of FIG. 2. Referring to FIGS. 1-6, a plurality of extruders 116 and corresponding hoppers 112 may be employed for adequate material delivery and lateral reach with minimal spreading. Each extruder 116 delivers the construction material 114 at a pressure, typically from a motor 174 driven auger 172, however other suitable pumping approaches may be employed. Each hopper 112 is configured to receive a granular supply of the construction material 114 and a liquid supply 170 such as water or similar additive for forming fluid concrete. The granular supply and the liquid supply 170 are in fluid communication with the hopper 112, or may be premixed and deposited in the hopper already in an aqueous, liquid state. Whether a single or multiple extruders 116 are invoked, a suitable backpressure in the nozzle 130 is achieved when an inlet to the nozzle 130 from the hopper 114 and an outlet defined by an area of collectively least cross section are selected such that the aggregate inlet has a cross sectional area equal to the aggregate outlet at the nozzle 130.

FIG. 7 shows an example of the control unit 105 including a processor control circuit for operation and guidance of the extrusion robot of FIG. 2. The electronic system architecture incorporated a combination of microcontrollers and computing devices, including two microcontrollers 701, 703, such as an ESP32 board, an Arduino® processor device 705, a Raspberry Pi®, and general PC/Windows®/Mac® device such as a laptop for general IO and UI (user interface) purposes. In the control architecture of FIG. 7, information flows from left to right. One ESP32 701, connected to the operator’s laptop, serves as a wireless controller. It transmits a custom G-code–like command structure, consisting of pump speeds, turntable orientation, and wheel speed, via ESP-NOW to the onboard ESP32 receiver 703, which forwards the commands via Serial to the Arduino 705 for processing. When required, the Arduino 705 also communicates status updates back to the onboard ESP32 703 for coordinated operational control. The Arduino 705 and onboard ESP32 703 collectively control all motors on the robot, including the transport drive 120 and the rotational linkage 140. The Arduino 705 drives five motors mounted beneath the baseboard—four for the drivetrain and one for the turntable—while the ESP32 independently controls the pump motors 174 for the extruder 116. The Raspberry Pi 707 communicates with the Arduino 705 over an I2C connection and uses a static IP address to interface directly with the scanner 124 (LiDAR) via Ethernet. During printing operations, the Raspberry Pi 707 continuously sends I2C-based corrections to the Arduino 705, adjusting wheel speeds to maintain alignment on the printed wall.

The LiDAR scanner 124 was placed at a downward angle near the front of the robot such that the sensor’s sixteen vertical scan layers could provide dense spatial coverage slightly in front of the turntable, either sensing the layer 150 in front for forward navigation, or evaluating the nozzles’ 130 performance when facing backwards. The Raspberry Pi 4B, running ROS2 Humble, served as the primary processing node for the LiDAR’s telemetry. ROS 2’s modular node-based architecture, using Fast DDS (Fast RTPS) middle ware for efficient publish–subscribe communication, supported a multi-stage filtering and processing pipeline to extract usable geometric features from raw LiDAR data and reliably detect the edges of the printed path. The LiDAR’s internal IMU was fused with data from an external chassis-mounted IMU to improve pose estimation and provide redundancy during operation. This sensing pipeline enabled reliable edge detection and orientation estimation, which were critical for autonomous path adjustments. By continuously aligning the robot’s trajectory with the detected edges, PRIMO maintained consistent positioning and accurate layer deposition during multi-layer printing.

The ESP32 is a powerful, low-cost, low-power system on a chip (SoC) microcontroller with integrated Wi-Fi and Bluetooth, commonly used for IoT projects, smart home automation, and camera applications. Other suitable SoC or similar microcontrollers may be employed.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. An autonomous extrusion unit for layered deposition of a construction material, comprising:
a hopper for aggregating the construction material;
an extruder for advancing the construction material from the hopper;
a transport drive configured to provide mobility of the unit; and
a nozzle coupled to the extruder for depositing the construction material in a traversable layer, the traversable layer configured for a subsequent pass by the transport drive.

2. The device of claim 1 wherein the nozzle has a shape for forming the traversable layer in a predetermined width and thickness, the nozzle extending the width beyond a width of the transport drive, the width of the layer accommodating the successive pass of the transport drive.

3. The device of claim 2 wherein the predetermined thickness defines a thickness of the construction material, the thickness based on a non-deforming bearing capacity of a weight of the unit during the subsequent pass.

4. The device of claim 1 further comprising a granular supply and a liquid supply, the granular supply and the liquid supply in fluid communication with the hopper.

5. The device of claim 1 further comprising a surface scanner, the surface scanner disposed on a forward transit side of the unit and coupled to the drive for returning signals indicative of a line of travel within the width and a termination of the traversable layer in a transit direction.

6. The device of claim 1 further comprising a rotational linkage between the transport drive and the nozzle, hopper and extruder, the rotational linkage configured to rotate the nozzle to an opposed side of the unit, the opposed side corresponding to deposition in an opposed direction from a travel direction for depositing the traversable layer.

7. The device of claim 1 wherein the nozzle includes a spreader, the spreader extending rearward from a transit direction of the unit for fluidic communication with the construction material, the spreader defining a height of the traversable layer above an accumulation of the traversable layers.

8. The device of claim 4 further comprising a replenishment inlet, the replenishment inlet in fluidic communication with the hopper for receiving additional granular supply.

9. The device of claim 8 wherein the replenishment inlet is coupled to at least one of a tubular vessel, an aerial drone and an external bulk carrier.

10. The device of claim 1 wherein the nozzle has an inlet from the hopper and at least one outlet, the outlet defined by an area of collectively least cross section, the inlet having a cross sectional area equal to the outlet.

11. A method of forming a structure, comprising:
establishing a fluidic aggregation of a construction material;
depositing the construction material onto a construction substrate;
spreading and smoothing the construction material into a traversable layer;
directing a transport drive over the traversable layer and depositing a subsequent traversable layer on top of the traversable layer, the traversable layer configured for a subsequent pass by the transport drive based on a width of the traversable layer being greater than a width of the transport drive.

12. The method of claim 11 further comprising deploying a plurality of units having the construction material for forming a structure from an aggregation of the layers.

13. A system for autonomous extrusion unit for layered deposition of a construction material, comprising:
a hopper for aggregating the construction material;
an extruder for advancing the construction material from the hopper;
a transport drive configured to provide mobility of the unit; and
a nozzle coupled to the extruder for depositing the construction material in a traversable layer, the traversable layer configured for a subsequent pass by the transport drive.

14. The system of claim 12 wherein the nozzle has a shape for forming the traversable layer in a predetermined width and thickness, the nozzle extending the width beyond a width of the transport drive, the width of the layer accommodating the successive pass of the transport drive.

15. The system of claim 12 further comprising a plurality of autonomous extrusion units having the construction material for forming a structure from an aggregation of the layers.
